(19) United States
(12) Patent Application Publication
(10) Pub. No.: US 2026/0343340 A1
(43) Pub. Date: Oct. 29, 2026

(54) EARLY INDICATION FOR DUAL CONNECTIVITY AND/OR CARRIER AGGREGATION

(71) Applicant: Nokia Technologies Oy, Espoo (FI)

(72) Inventors: Ali KARIMIDEHKORDI, Munich (DE); Ahmad AWADA, Munich (DE); Halit Murat GÜRSU, Munich (DE); Niko KOLEHMAINEN, Espoo (FI); Lars DALSGAARD, Oulu (FI); Tero HENTTONEN, Espoo (FI); Jani-Pekka KAINULAINEN, Cambridge (GB)

(21) Appl. No.: 19/123,489

(22) PCT Filed: Nov. 3, 2022
(86) PCT No.: PCT/EP2022/080628

§ 371 Date: Apr. 23, 2025

(51) Int. Cl. H04W 36/00

(52) U.S. Cl. CPC H04W 36/00692; H04W 36/0077

(57) ABSTRACT

Method comprising: monitoring whether a base station receives an indication from a terminal within a connection establishment procedure for connecting the terminal with the base station in a connected state that a condition is met by performance measurements of at least one candidate cell performed while the terminal was not in the connected state, wherein the connection establishment procedure comprises: a random access procedure, or a connection setup request, or a connection resume request; if the indication is received: ⋅requesting each of the candidate cells to prepare as a secondary cell for carrier aggregation or dual connectivity for the terminal; ⋅determining a suitable cell of the candidate cells, wherein the performance measurement of the suitable cell meets the condition; ⋅providing the terminal with a configuration comprising the suitable cell as a secondary cell; ⋅informing the suitable cell that the terminal is configured with the suitable cell as the secondary cell.

### FIELD OF THE INVENTION

The present disclosure relates to dual connectivity and/or carrier aggregation.

### ABBREVIATIONS

3GPP 3^{rd} Generation Partnership Project
5G/6G/7G 5^{th}/6^{th}/7^{th} Generation
AMF Access and Mobility Function
AoA Angle of Arrival
AR Augmented Reality
AS Access Stratum
CA Carrier Aggregation
CM Connection Management
CSSF Carrier-specific Scaling Factor
DC Dual Connectivity
DL Downlink
DN Domain Name
DRB Data Radio Bearer
DRX Discontinuous Reception
EMR Early Measurement Report
FR Frequency Range
gNB next Generation NodeB
IAB-MT Integrated Access and Backhaul-Mobile Termination
I-RNTI Inactive RNTI
MN Master Node
Msg Message
NAS Non-Access Stratum
NR New Radio
PDU Protocol Data Unit
PRACH Physical Random Access Channel
PSCell Primary Serving Cell
RA Random Access
RAN Radio Access Network
RNTI Radio Network Temporary Identifier
RRC Radio Resource Control
RRM Radio Resource Management
RSRP Reference Signal Received Power
RSRQ Reference Signal Received Quality
Rx Receive (r)
SCell Secondary Cell
SCG Secondary Cell Group
SgNB Secondary gNB
SMTC SSB-based RRM Measurement Timing Configuration
SN Secondary Node
SRB Signaling Radio Bearer
SSB Synchronization Signal Block
TDM Time Division Multiplex
TR Technical Report
TS Technical Specification
Tx Transmit (ter)
UE User Equipment
UL Uplink
URLLC Ultra-reliable low latency Communication
XR Extended Reality

### BACKGROUND

In carrier aggregation (CA), capabilities of radio cells at distinct frequencies allocations are combined. The UE first connects to one carrier for both uplink and downlink. This is the PCell. Thereafter, secondary DL carriers may be added (SCells).

Dual Connectivity (DC) enables aggregation of two radio links with non-ideal backhaul without low-latency requirements. To allow this, the links are aggregated at the PDCP level, combining PDCP PDUs. This is different from CA (Carrier Aggregation) that combines MAC-layer blocks. For resource aggregation, UE in RRC_CONNECTED state is allocated two radio links from two different network nodes utilizing regular X2-connectivity and connected via a non-ideal backhaul. The nodes play different roles. Macro-Cell serves as mobility and signaling anchor (called Master eNB, terminating S1-MME) and Small Cell serves as a local “capacity booster” (called Secondary eNB, providing additional radio resources for UE). The two resource sets involved in the process are termed as Master Cell Group (MCG, associated with MeNB, and comprising of a PCell and zero, one or more SCells) and Secondary Cell Group (SCG, associated with SeNB, and comprising of PSCell (Primary SCell) and zero, one or more SCells). The term “MN” denotes any of the PCell and SCell(s) of the MCG, and the term “SN” denotes any of the PSCell and SCell(s) of the SCG.

For the purposes of the present application, DC and CA may be used equivalently. I.e., unless otherwise stated, if the description relates to one of DC or CA, the description is correspondingly applicable to the other of DC and CA. Usually, this equivalency is expressed by “DC/CA” which means any of DC and CA.

For the purpose of the present application, the terms “idle mode” and connected mode” are used such that the UE is both in RRC idle mode and CM idle mode and in both RRC connected mode and CM connected mode, respectively, unless otherwise stated. While a gNB does not maintain the UE context in the RRC idle mode, the last serving gNB maintains the UE context while the UE is in RRC_INACTIVE mode. Accordingly, if the UE is in RRC inactive mode, it is in CM connected mode.

As proposed in Release-18 Further NR Mobility Enhancements work item description [3GPP RP-213565], an objective is to study FR2 SCG/SCell measurement acquisition procedures and investigate potential enhancements and mechanisms to improve FR2 DC/CA setup/resume delays including user in RRC idle/inactive states.

### SUMMARY

It is an object of the present invention to improve the prior art.

According to a first aspect of the invention, there is provided an apparatus comprising:
one or more processors, and memory storing instructions that, when executed by the one or more processors, cause the apparatus to perform:
monitoring whether a base station receives an indication from a terminal within a connection establishment procedure of the terminal for connecting the terminal with the base station in a connected state that a condition is met by performance measurements of at least one of one or more candidate cells performed while the terminal was not in the connected state, wherein the connection establishment procedure comprises at least one of the following: a random access procedure of the terminal, or a connection setup request of the terminal, or a connection resume request of the terminal;
if the indication is received from the terminal:
   requesting each of the one or more candidate cells to prepare as a secondary cell for carrier aggregation or dual connectivity for the terminal;
   determining a suitable cell of the one or more candidate cells, wherein the performance measurement of the suitable cell meets the condition;
   providing the terminal with a configuration comprising the suitable cell as a secondary cell;
   informing the suitable cell that the terminal is configured with the suitable cell as the secondary cell.

The instructions, when executed by the one or more processors, may further cause the apparatus to perform
providing the terminal with a set of one or more preambles; wherein
the monitoring whether an indication is received from the terminal within the connection establishment procedure of the terminal that the condition is met by the performance measurements of at least one candidate cell comprises monitoring whether the terminal uses one of the preambles of the set of one or more preambles in the random access procedure.

The instructions, when executed by the one or more processors, may further cause the apparatus to perform
providing the terminal with an indication of a dedicated random access channel occasion; wherein
the monitoring whether an indication is received from the terminal within the connection establishment procedure of the terminal that the condition is met by the performance measurements of at least one candidate cell by monitoring whether the terminal selects the dedicated random access channel occasion in the random access procedure.

The instructions, when executed by the one or more processors, may cause the apparatus to perform
the monitoring whether an indication is received from the terminal within the connection establishment procedure of the terminal that the condition is met by the performance measurements of at least one candidate cell by monitoring whether the terminal provides an explicit indication in the connection setup request or the connection resume request.

The instructions, when executed by the one or more processors, may further cause the apparatus to perform at least one of the following:
providing the terminal with a measurement configuration for the performance measurements; or
providing the terminal with the condition.

The instructions, when executed by the one or more processors, may further cause the apparatus to perform, if there are more than one candidate cells:
releasing the candidate cells different from the suitable cell from becoming a secondary cell for carrier aggregation or dual connectivity for the terminal.

The instructions, when executed by the one or more processors, may cause the apparatus to perform, if there are more than one candidate cells:
the providing the terminal with the configuration comprising the suitable cell as the secondary cell by providing the terminal with a respective configuration for each of the candidate cells, wherein each of the configurations comprises the respective one of the candidate cells as the secondary cell; and
instructing the terminal to select the suitable cell among the candidate cells and to apply only the configuration for the suitable cell.

The instructions, when executed by the one or more processors, may cause the apparatus to perform
the providing the terminal with the respective configuration for each of the candidate cells not later than the requesting the report of the performance measurements from the terminal.

The instructions, when executed by the one or more processors, may cause the apparatus to perform, if there are more than one candidate cells:
the providing the terminal with the configuration comprising the suitable cell as the secondary cell by providing the terminal with only the configuration comprising the suitable cell as the secondary cell after the determining the suitable cell.

The indication may comprise an indication of the suitable cell.

The instructions, when executed by the one or more processors, may further cause the apparatus to perform
requesting a report of the performance measurements from the terminal; and
the determining the suitable cell of the one or more candidate cells by analyzing the report of the performance measurements.

The instructions, when executed by the one or more processors, may further cause the apparatus to perform
estimating the candidate cells among a set of potential candidate cells based on information about a primary cell the terminal is camping on.

The performance measurements may comprise early measurement report measurements.

According to a second aspect of the invention, there is provided an apparatus comprising:
one or more processors, and memory storing instructions that, when executed by the one or more processors, cause the apparatus to perform:
monitoring whether a terminal has left a connected state and performs performance measurements of one or more candidate cells while not being in the connected state;
if the terminal has left the connected state and performs the performance measurements while not being in the connected state:
   checking whether at least one of the performance measurements meets a condition;
   supervising whether the terminal intends to connect with a base station in the connected state by a connection establishment procedure, wherein the connection establishment procedure comprises at least one of the following: a random access procedure of the terminal, or a connection setup request of the terminal, or a connection resume request of the terminal;
   if at least one of the performance measurements meets the condition and the terminal intends to connect with the base station in the connected state by the connection establishment procedure: providing an indication to the base station within the connection establishment procedure, wherein the indication indicates that at least one of the performance measurements meets the condition.

The instructions, when executed by the one or more processors, may cause the apparatus to perform:
the providing by providing an explicit indication in the connection setup request or the connection resume request.

The instructions, when executed by the one or more processors, may further cause the apparatus to perform
monitoring whether the terminal receives a set of one or more preambles; and wherein the instructions, when executed by the one or more processors, may cause the apparatus to perform
the providing the indication by using one of the preambles of the set of one or more preambles in the random access procedure.

The instructions, when executed by the one or more processors, may further cause the apparatus to perform
monitoring whether the terminal receives an indication of a random access channel occasion; and wherein the instructions, when executed by the one or more processors, may cause the apparatus to perform
the providing the indication by selecting the random access channel occasion in the random access procedure.

The instructions, when executed by the one or more processors, may further cause the apparatus to perform at least one of the following:
receiving a measurement configuration for the performance measurements, or
receiving the condition.

The instructions, when executed by the one or more processors, may further cause the apparatus to perform
monitoring whether the terminal receives a configuration from the base station, wherein the configuration comprises one of the candidate cells as a secondary cell for the terminal;
applying the configuration to the terminal if the terminal receives the configuration.

The instructions, when executed by the one or more processors, may further cause the apparatus to perform, if the measurement configuration comprises performance measurements of more than one candidate cell:
monitoring whether the terminal receives, from the base station, for each of the candidate cells, a respective configuration and an instruction to select only one of the configurations, wherein each of the configurations comprises the respective candidate cell as the secondary cell for the terminal;
selecting one of the candidate cells based on results of the performance measurements for the candidate cells if the terminal receives the configurations for the candidate cells and the instruction;
applying only the configuration for the selected candidate cell to the terminal.

The indication may indicate additionally the candidate cell for which the performance measurement meets the condition.

The performance measurements may comprise early measurement report measurements.

According to a third aspect of the invention, there is provided a method comprising:
monitoring whether a base station receives an indication from a terminal within a connection establishment procedure of the terminal for connecting the terminal with the base station in a connected state that a condition is met by performance measurements of at least one of one or more candidate cells performed while the terminal was not in the connected state, wherein the connection establishment procedure comprises at least one of the following: a random access procedure of the terminal, or a connection setup request of the terminal, or a connection resume request of the terminal;
if the indication is received from the terminal:
   requesting each of the one or more candidate cells to prepare as a secondary cell for carrier aggregation or dual connectivity for the terminal;
   determining a suitable cell of the one or more candidate cells, wherein the performance measurement of the suitable cell meets the condition;
   providing the terminal with a configuration comprising the suitable cell as a secondary cell;
   informing the suitable cell that the terminal is configured with the suitable cell as the secondary cell.

The method may further comprise
providing the terminal with a set of one or more preambles; wherein
the monitoring whether an indication is received from the terminal within the connection establishment procedure of the terminal that the condition is met by the performance measurements of at least one candidate cell may comprise monitoring whether the terminal uses one of the preambles of the set of one or more preambles in the random access procedure.

The method may further comprise
providing the terminal with an indication of a dedicated random access channel occasion; wherein
the monitoring whether an indication is received from the terminal within the connection establishment procedure of the terminal that the condition is met by the performance measurements of at least one candidate cell may comprise monitoring whether the terminal selects the dedicated random access channel occasion in the random access procedure.

The monitoring whether an indication is received from the terminal within the connection establishment procedure of the terminal that the condition is met by the performance measurements of at least one candidate cell may comprise monitoring whether the terminal provides an explicit indication in the connection setup request or the connection resume request.

The method may further comprise:
providing the terminal with a measurement configuration for the performance measurements; or
providing the terminal with the condition.

The method may further comprise:
releasing the candidate cells different from the suitable cell from becoming a secondary cell for carrier aggregation or dual connectivity for the terminal.

The providing the terminal with the configuration comprising the suitable cell as the secondary cell may comprise providing the terminal with a respective configuration for each of the candidate cells, wherein each of the configurations comprises the respective one of the candidate cells as the secondary cell; and the method may further comprise
instructing the terminal to select the suitable cell among the candidate cells and to apply only the configuration for the suitable cell.

The terminal may be provided with the respective configuration for each of the candidate cells not later than the requesting the report of the performance measurements from the terminal.

The providing the terminal with the configuration comprising the suitable cell as the secondary cell may comprise providing the terminal with only the configuration comprising the suitable cell as the secondary cell after the determining the suitable cell.

The indication may comprise an indication of the suitable cell.

The method may further comprise
requesting a report of the performance measurements from the terminal; wherein
the determining the suitable cell of the one or more candidate cells may be performed by analyzing the report of the performance measurements.

The method may further comprise
estimating the candidate cells among a set of potential candidate cells based on information about a primary cell the terminal is camping on.

The performance measurements may comprise early measurement report measurements.

According to a fourth aspect of the invention, there is provided a method comprising:
one or more processors, and memory storing instructions that, when executed by the one or more processors, cause the method to perform:
monitoring whether a terminal has left a connected state and performs performance measurements of one or more candidate cells while not being in the connected state;
if the terminal has left the connected state and performs the performance measurements while not being in the connected state:
   checking whether at least one of the performance measurements meets a condition;
   supervising whether the terminal intends to connect with a base station in the connected state by a connection establishment procedure, wherein the connection establishment procedure comprises at least one of the following: a random access procedure of the terminal, or a connection setup request of the terminal, or a connection resume request of the terminal;
   if at least one of the performance measurements meets the condition and the terminal intends to connect with the base station in the connected state by the connection establishment procedure: providing an indication to the base station within the connection establishment procedure, wherein the indication indicates that at least one of the performance measurements meets the condition.

The providing may comprise providing an explicit indication in the connection setup request or the connection resume request.

The method may further comprise
monitoring whether the terminal receives a set of one or more preambles; and wherein
the providing the indication may comprise using one of the preambles of the set of one or more preambles in the random access procedure.

The method may further comprise
monitoring whether the terminal receives an indication of a random access channel occasion; and wherein
the providing the indication may comprise selecting the random access channel occasion in the random access procedure.

The method may further comprise at least one of the following:
receiving a measurement configuration for the performance measurements, or
receiving the condition.

The method may further comprise
monitoring whether the terminal receives a configuration from the base station, wherein the configuration comprises one of the candidate cells as a secondary cell for the terminal;
applying the configuration to the terminal if the terminal receives the configuration.

The method may further comprise, if the measurement configuration comprises performance measurements of more than one candidate cell:
monitoring whether the terminal receives, from the base station, for each of the candidate cells, a respective configuration and an instruction to select only one of the configurations, wherein each of the configurations comprises the respective candidate cell as the secondary cell for the terminal;
selecting one of the candidate cells based on results of the performance measurements for the candidate cells if the terminal receives the configurations for the candidate cells and the instruction;
applying only the configuration for the selected candidate cell to the terminal.

The indication may indicate additionally the candidate cell for which the performance measurement meets the condition.

The performance measurements may comprise early measurement report measurements.

Each of the methods of the third and fourth aspects may be a method of dual connectivity and/or carrier aggregation.

According to a fifth aspect of the invention, there is provided a computer program product comprising a set of instructions which, when executed on an apparatus, is configured to cause the apparatus to carry out the method according to any of the third and fourth aspects. The computer program product may be embodied as a computer-readable medium or directly loadable into a computer.

According to some embodiments of the invention, at least one of the following advantages may be achieved:
the UE is connected faster to the secondary node.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein:

FIG. 1 illustrates EMR measurements and the function of the T331 timer according to the prior art;

FIG. 2 shows a message sequence chart for a transition from idle mode with EMR measurements to connected mode according to the prior art;

FIG. 3 shows a message sequence chart for a transition from inactive mode with EMR measurements to connected mode according to the prior art;

FIG. 4 shows a message sequence chart for a transition from idle mode with EMR measurements to connected mode according to some example embodiments of the invention;

FIG. 5 shows a message sequence chart for a transition from inactive mode with EMR measurements to connected mode according to some example embodiments of the invention;

FIG. 6 shows an apparatus according to an example embodiment of the invention;

FIG. 7 shows a method according to an example embodiment of the invention;

FIG. 8 shows an apparatus according to an example embodiment of the invention;

FIG. 9 shows a method according to an example embodiment of the invention; and

FIG. 10 shows an apparatus according to an example embodiment of the invention.

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given by way of example only, and that it is by no way intended to be understood as limiting the invention to the disclosed details.

Moreover, it is to be understood that the apparatus is configured to perform the corresponding method, although in some cases only the apparatus or only the method are described.

Millimetre-Wave (mm-wave) Communications

To compensate for the additional propagation path-loss of transmission in mm-wave frequencies (e.g., FR2) compared to FR1, the gNBs are typically equipped with a relatively high number of antenna elements where signals are beamformed and transmitted through different spatial filtered narrow beams.

On the UE-side, unlike FR1 device architecture in which devices are mostly built with a single antenna panel (with spherical coverage), to provide full special coverage in FR2, devices are expected to be equipped with multiple directional antenna panels (Rx/Tx beams) located, for example, at different sides of the device, each covering part of the space. In NR networks, initial connection (cell detection/measurement) establishment procedure and beam selection phase are performed by measuring SSBs broadcasted from the gNB through different spatial filters that are multiplexed and swept in the TDM manner. In NR FR2, due to the assumption of multiple UE antenna panels (in general directional Rx and Tx), the UE cell detection and measurement time is relaxed compared to FR1. Currently RAN4 assumes that the user can receive from only one Rx panel (one spatial direction) at a time. Therefore, to measure a cell/carrier frequency properly, the UE is assumed to consecutively measure the reference signals by sweeping its receive panels, which results in additional measurement time compared to that required for single panel UE, such as those typically used in FR1 [3GPP TS 38.133].

### Inter-Frequency Measurement to Establish DC/CA

To improve the user throughput as well as data transmission latency (e.g., reducing packet queuing/buffering delay), and reliability, it is important to reduce secondary link establishment/resume delay(s) for PSCell/SCell setup in DC/CA operation scenarios. Especially for a UE connecting from idle/inactive states where network information is limited related to available UE measurement status.

To setup a DC/CA connection the UE has to measure, and report configured inter-frequency carriers. It has been shown that measurement acquisition delay is the main component contributing to DC/CA setup delay [3GPP R4-2212869].

As an example and based on connected-mode UE measurement requirement provided in [3GPP TS 38.133] and performed analysis detailed in [3GPP R4-2212869], assuming gap assisted measurements, a FR2 UE (Mpss/sss_sync_inter=40, Mmeas_period_inter=40, MssB_index_inter=24), and SMTC periodicity of 40 msec, no DRX, measurement gap repetition period (MGRP) of 40 msec, and no co-configured/concurrent measurement (i.e., CSSFinter=1), the measurement acquisition delay equals:

$${T ( FR 2 )}_{identify \_ inter \_ with \_ index} = ( {T}_{PSS / SSS \_ sync \_ inter} + {T}_{SSB \_ measurement \_ period \_ inter} + {T}_{SSB \_ time \_ index \_ inter} ) = 40 * 40 + 40 * 40 + 24 * 40 = 4160 msec$$

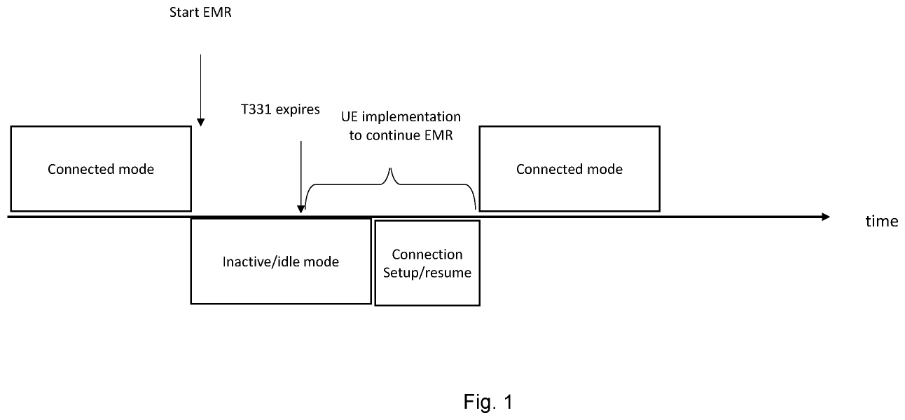

To avoid such a high delay especially for a UE connecting from idle/inactive mode, EMR has been proposed in NR Rel-16 to enable faster DC/CA setup by configuring the UE to perform measurements in idle/inactive mode on potential DC/CA frequencies/cells (EMR measurements) while a specific timer (T331) is running. These measurements are typically performed on a carrier different from the carrier of the Pcell. The UE prepares a report of the EMR measurements and sends it to the network once entering into the RRC-connected mode. That resolves the need for measurements in connected mode. After T331 expiry, it is up to the UE implementation whether to continue the measurement or not. FIG. 1 shows an example of

UE transiting from connected mode to idle mode, T331 timer expiry event, and transiting back into connected mode.

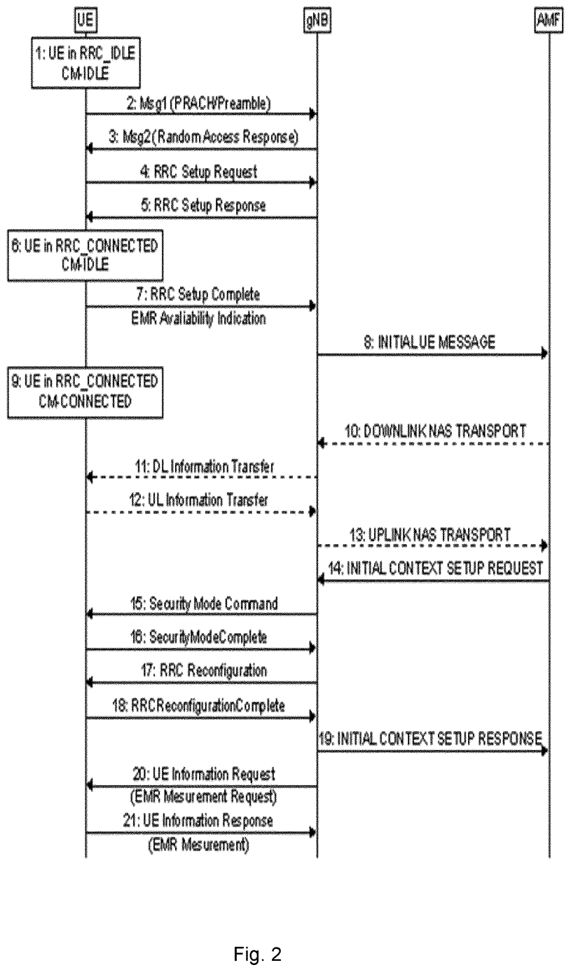

FIG. 2 shows a corresponding message sequence chart for the transition from idle mode to connected mode according to the prior art. The actions are substantially as follows:
Action #1: UE is in the idle-mode and performs EMR measurement of DC/CA carriers.
Actions #2-3: UE sends a pre-configured RA preamble and receives the RA response from the gNB. These actions form a “random access procedure”.
Action #4: The UE requests to setup a new connection from RRC_IDLE by sending an RRC Setup Request message to the gNB.
Action #5: The gNB sends RRC setup response to the UE.
Action #6: The UE is in RRC connected mode but still in CM idle mode.
Action #7: The UE sends the RRC Setup Complete message to the network, which may include EMR availability indication.
Action #8: The first NAS message from the UE, piggybacked in RRCSetupComplete, is sent to AMF.
Action #9: The UE is now in RRC connected mode and in CM connected mode.
Actions #10-13: Additional NAS messages may be exchanged between UE and AMF, see 3GPP TS 23.502
Action #14: The AMF prepares the UE context data (including PDU session context, the Security Key, UE Radio Capability and UE Security Capabilities, etc.) and sends it to the gNB.
Actions #15-16: The gNB activates the AS security with the UE.
Actions #17-18: The gNB performs the reconfiguration to setup SRB2 and DRBs for UE, or SRB2 and optionally DRBs for IAB-MT.
Action #19: The gNB informs the AMF that the setup procedure is completed.
Actions #20-21: The gNB sends EMR measurement request to the UE and the UE responds by sending the EMR measurement report.

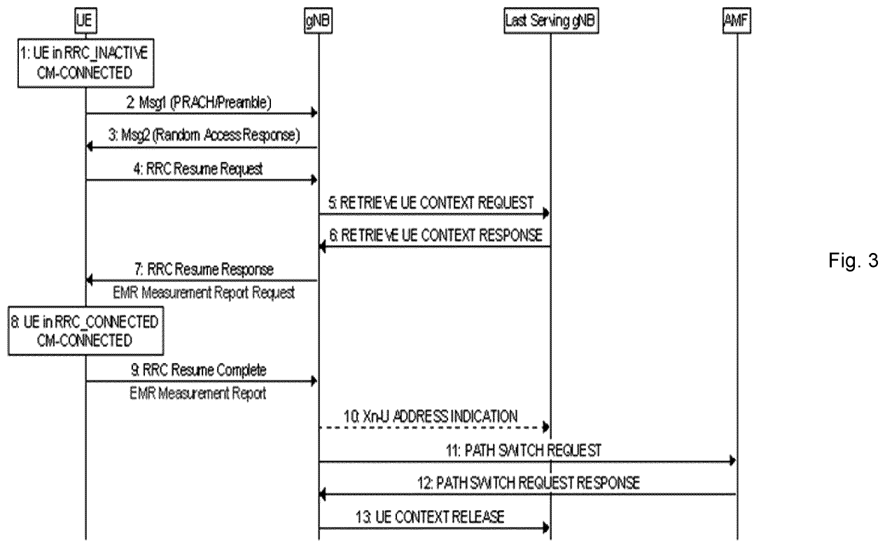

FIG. 3 illustrates the transition of the UE from RRC_INACTIVE mode to RRC_CONNECTED mode, triggered by the UE, according to the prior art. The actions are substantially as follows:
Action #1: UE is in the inactive-mode and performs EMR measurement of DC/CA carriers.
Actions #2-3: UE sends a pre-configured RA preamble and receives the RA response from the gNB. These actions form a “random access procedure”.
Action #4: The UE resumes the RRC connection from RRC_INACTIVE, providing the I-RNTI, allocated by the last serving gNB.
Action #5: The gNB, if able to resolve the gNB identity contained in the I-RNTI, requests the last serving gNB to provide UE Context data.
Action #6: The last serving gNB provides UE context data.
Actions #7-9: The gNB and UE completes the resumption of the RRC connection, and the UE reports EMR measurement to the network.
Action #10: If loss of DL user data buffered in the last serving gNB shall be prevented, the gNB provides forwarding addresses.
Actions #11-12: Additional NAS messages may be exchanged between UE and AMF, see 3GPP TS 23.502.
Action #13: The gNB triggers the release of the UE resources at the last serving gNB.

As described hereinabove, to initiate the preparation and establish PScell/Scell in DC/CA the network waits for the EMR measurement which are available after complete connection establishment (and exchanging security keys). This includes exchanging several messages between the UE and network plus processing time. These actions delay DC/CA setup. This is especially detrimental for applications with high throughput and low-latency requirement (such as XR, AR), or application that needs DC/CA to enhance the reliability such as ultra-reliable low-latency communications (URLLC).

Some example embodiments of the invention speedup DC/CA setup for a UE transitioning from RRC idle mode or RRC inactive mode to RRC connected mode.

According to some example embodiments of the invention, the UE provides the network with EMR related information in the connection establishment procedure comprising a random access procedure (e.g. when sending the RA preamble). Some main actions are as follows:
Action #1: The network configures the UE to perform a EMR measurement (including enhanced EMR configuration, e.g. rel-18 eEMR configuration), i.e. a performance measurement in idle or inactive mode.
Action #2: The network assigns a set of RA preambles to the UE and configures it to use them when performing RA if certain conditions are satisfied during EMR measurement evaluation. As an example, this could be detecting a cell with quality and/or power (RSRQ and/or RSRP) threshold above a certain threshold (additional details/examples are provided below). The network may provide the UE with the conditions, too, or the conditions may be predefined in the UE. If the network provides the conditions, it has typically prevalence over preconfigured conditions.
Action #3: During RA if the measurement condition holds, the UE performs the RA by sending a preamble among the set of RA preambles.
Action #4: Based on the received indication and by possibly combining it with position information of the camped PCell (AoA estimation beam that is accessed during RACH and location of PCell), the network can estimate potential PScells/SCells and prepare them for DC/CA.
Action #5: After receiving EMR report, the network can immediately trigger DC/CA setup with the correct prepared cells and send release message to the other candidates that are not selected by the network for DC/CA setup.

As further options, the UE may indicate to the network that the condition is fulfilled in other ways within the connection establishment procedure, for example by selecting a dedicated RACH occasion and/or by an explicit indication in the RRC setup request following the RA procedure (for transition from RRC idle mode) or in the RRC resume request following the RA procedure (for transition from RRC inactive mode). In this case, the network may or may not provide the set of RA preambles to the UE. In some example embodiments, if the UE receives the set of preambles, the UE may indicate that the condition is fulfilled by either using a preamble of the set of preambles, or by selecting the dedicated RACH occasion, or by a explicit indication in the RRC setup request or RRC resume request. In some example embodiments, the UE indicates that the condition is fulfilled by two or three of using a preamble of the set of preambles, selecting a dedicated RACH occasion, and an explicit indication in the RRC setup request or RRC resume request.

In some example embodiments, the indication provided in the connection establishment procedure (e.g. preamble, RACH occasion and/or explicit indication) may not only indicate that one of the measured cells of the EMR measurements fulfils the conditions but may also indicate which of the measured cells fulfils the condition. In some example embodiments, the gNB requests from the UE the EMR measurement report and evaluates the same to decide which of the measured cells fulfils the conditions (is a suitable cell).

An advantage of these example embodiments is that they reduce the delays for SN addition setup (the preparation phase of DC/CA) and faster establish the DC/CA without waiting for receiving complete EMR report and additional UE reconfiguration delay.

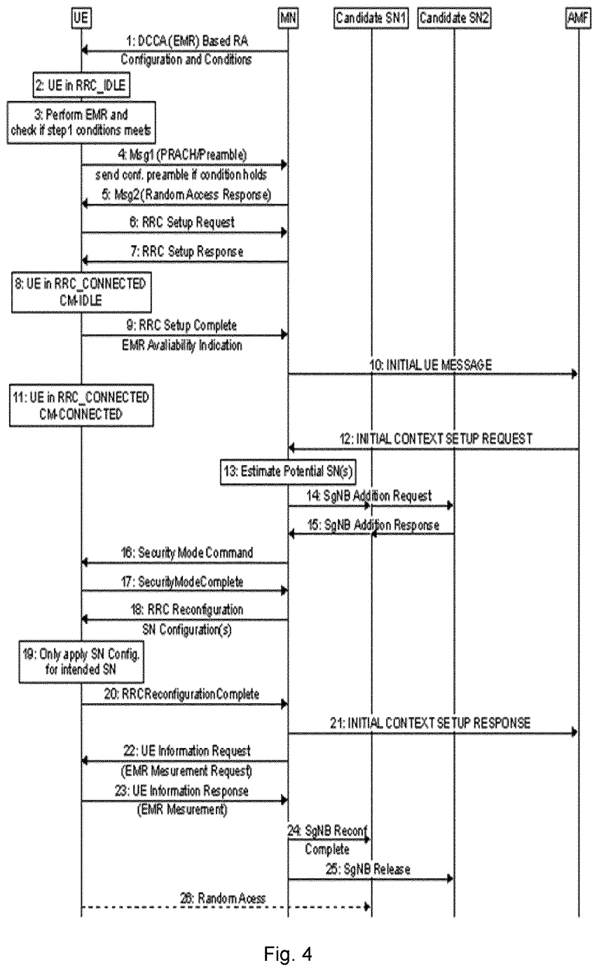

FIG. 4 illustrates a message sequence chart according to some example embodiments of the invention. The message sequence chart is for a transition from idle mode to connected mode. Actions not described (or not described in detail) correspond to the actions described with respect to FIG. 2. The procedure of FIG. 4 uses the option of dedicated preambles. Corresponding procedures apply for the options of dedicated RACH occasions and explicit indication. The actions in FIG. 4 are substantially as follows:
Action 1: The gNB configures the UE with a set of preambles for indicating if certain conditions are met during EMR measurement. This can be described also as “type of eEMR”. The conditions could be for example:
   Finding a cell with RSRP (signal strength) or RSRQ (signal quality) value above a certain threshold.
      The list of PSCell/SCell whose signal is checked against the threshold may be indicated by the MN.
   Previous serving SN cell (before transitioning to idle mode) is known, and the received signal has a good quality (for low mobility UEs).
      If needed, the UE may provide to the gNB one of the following pieces of information instead of or in addition to the indication that the condition is met:
EMR Measurement are outdated or invalid
EMR Measurement are ongoing.
EMR Measurement validation is ongoing.
   If the network (gNB) knows that EMR measurement are outdated or invalid the network may rapidly configure the UE with improved/enhanced measurements. If EMR measurements are ongoing (or not validated yet) the network may decide not to configure the UE with additional measurements which may further delay the EMR measurements.

The mapping of the preambles (or RACH occasions) to the PSCells or SCells can be indicated to the UE through a broadcast signaling or through UE dedicated signalling.
In case of UE dedicated signalling, the preamble or RACH occasion to the PSCell or SCell mapping can be shared among RAN nodes, so the RAN node, while releasing the UE, may indicate the mapping information for neighbouring RAN nodes. So UE would know which preamble or RACH occasion to select in case UE is roaming towards those RAN nodes.
This information may come with a list of cells that the information is valid at, and UE may disable this feature if it is camping on a cell for which this information is not signaled to it.
Action 2: The UE transitions in idle mode.
Action 3: UE performs the EMR measurements and checks if the conditions for the EMR measurements of at least one of the candidate nodes are met.
Action 4: When performing RA the UE uses the predefined (configured) RA preamble if the conditions is met.
Actions 5 to 12 correspond to the same actions in FIG. 2.
Actions 13 to 15: Based on the information of the camped Pcell (option) (and also optionally based on SSB beam used for RA transmission), and EMR configuration, the MN estimates potential PScells and/or Scells) and initiates the DC/CA preparation by communicating with these potential PScells and/or Scells through SN addition request and response.
Action 18: The MN provides the UE with candidate SN configurations and configures it to only apply the configurations that match with the conditions on the UE EMR measurement.
Action 19: The UE applies the SN configurations that matches with the conditions on the EMR measurement.
   In one option (or alternative), the MN provides to the UE the SN configuration corresponding to the suitable PSCell/SCell after receiving the EMR report in action 23. Herein, the suitable PSCell/SCell may correspond to the one having the strongest reported measurement in the EMR report.
Actions 20 to 23 correspond to the same actions in FIG. 2.
Action 24-25: based on the detailed EMR report the MN sends the SN reconfiguration complete to the suitable (selected) SN and SN release to the other candidate SNs.
Action 26: the UE performs the RA towards the suitable (selected) SN.

An advantage of some example embodiments is that the UE can be connected faster to the SN based on the EMR measurement, while in legacy procedure, the MN needs to wait for EMR report (step 23) to identify and then configure the SN. After that, the SN configuration needs to be sent to the UE and UE will take some time to apply the SN configuration. Then, the UE sends further the SN configuration complete to the target SN before it can start using DCCA.

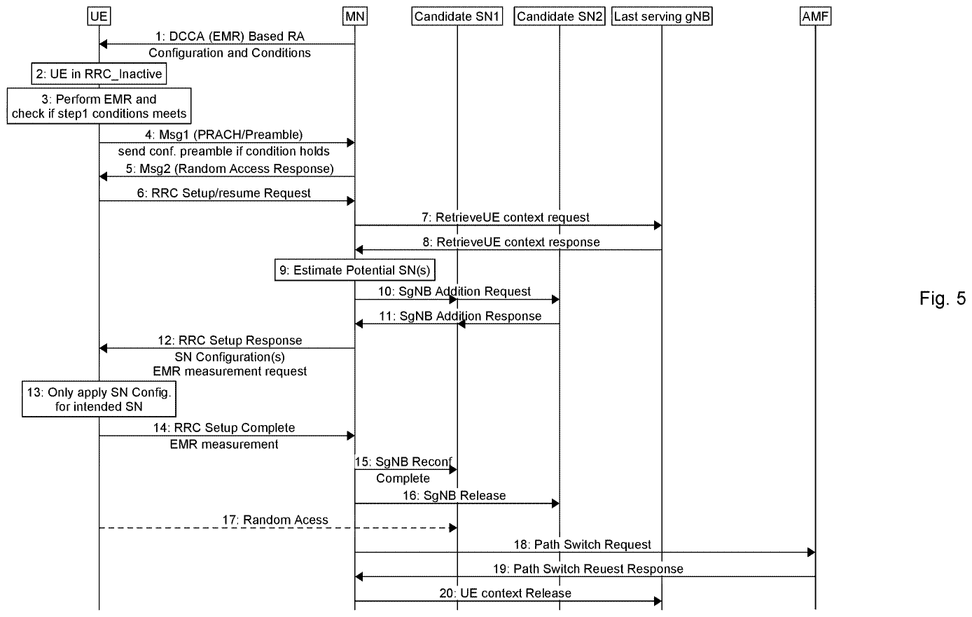

FIG. 5 illustrates a message sequence chart according to some example embodiments of the invention. The message sequence chart is for a transition from RRC inactive mode to connected mode. Actions not described (or not described in detail) correspond to the actions described with respect to FIG. 3.

The procedure of FIG. 5 uses the option of dedicated preambles. Corresponding procedures apply for the options of dedicated RACH occasions and explicit indication. The procedure of FIG. 5 includes the following actions:
Action 1: The gNB configures the UE with a set of preambles for indicating if certain conditions are met during EMR measurement. This can be described also as “type of eEMR”. The conditions and the indication of the mapping ay be the same as described with respect to FIG. 4.
Action 2: The UE transitions in RRC inactive mode.
Action 3: UE performs the EMR measurements and checks if the conditions for the EMR measurements of at least one of the candidate nodes are met.
Action 4: When performing RA the UE uses the predefined (configured) RA preamble if the conditions is met.
Actions 5 to 8 correspond to the same actions in FIG. 3.
Actions 9 to 11: Based on the information of the camped Pcell (option) (and also optionally based on SSB beam used for RA transmission), and EMR configuration, the MN estimates potential PScells and/or Scells) and initiates the DC/CA preparation by communicating with these potential PScells and/or Scells through SN addition request and response.
Action 12: The gNB requests, in the RRC Setup response the EMR measurements. The RRC Setup response may comprise plural SN configurations, one for each of the candidate SNs.
Action 13: The UE applies the SN configurations that matches with the conditions on the EMR measurement.
   In one option (or alternative), the MN provides to the UE the SN configuration corresponding to the suitable PSCell/SCell after receiving the EMR report in action 23. Herein, the suitable PSCell/SCell may correspond to the one having the strongest reported measurement in the EMR report.
Action 14: With the RRC Complete message, the UE provides the EMR measurement report to the gNB.
Actions 15 to 16: based on the detailed EMR report the MN sends the SN reconfiguration complete to the suitable (selected) SN and SN release to the other candidate SNs.
Actions 17 to 20 correspond to the prior art for adding the selected candidate as a SCell or PSCell.

As described hereinabove, some example embodiments of the invention provide one or more of the following options. Each option of each of the categories may be combined with each option of any of the other categories. The categories are as follows:
Options to inform the gNB that one or more conditions are met by at least one of the EMR measurements:
   preamble
   RACH occasion
   explicit indication in RRC setup request or RRC resume request.
Options for the gNB to determine the suitable cell:
   the indication from the UE that the condition is met by at least one EMR measurement may comprise an indication of the cell for which the EMR measurement meets the condition; i.e., the gNB may determine the suitable cell from the indication;
   evaluating the EMR measurement report.
Options to provide the UE with the condition:
   condition is predefined in UE (e.g. according to some 3GPP specification)
   gNB provides the condition to UE in RRC connection state.

In some example embodiments, more than one of the options of one category may be combined. In such cases, one of the options may have prevalence of another of the options, or both options have to be fulfilled, depending on implementation.

gNB may select all the cells for which it configures EMR measurements in the UE as candidate cells for Scell or PScell and configure them accordingly by SgNB addition request. In some example embodiments, it may restrict the number of candidate cells based on other measurements such as AoA.

If the indication from the UE comprises the indication of the suitable candidate cell, gNB may adopt this selection. As another option, or if the indication from the UE does not comprise the indication of the suitable candidate cell, gNB may select the suitable candidate cell based on the EMR measurement report from the UE. Even then, the configuration is faster because the suitable cell is preconfigured as a Scell or PScell.

There may be one cell or more than one cell to be added as Scell or PScell.

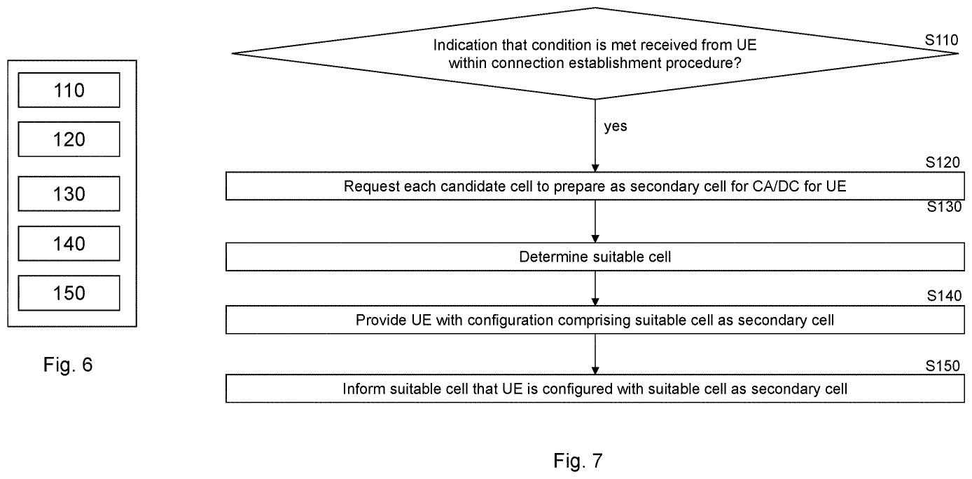

FIG. 6 shows an apparatus according to an example embodiment of the invention. The apparatus may be base station (e.g. eNB or gNB) or an element thereof. FIG. 7 shows a method according to an example embodiment of the invention. The apparatus according to FIG. 6 may perform the method of FIG. 7 but is not limited to this method. The method of FIG. 7 may be performed by the apparatus of FIG. 6 but is not limited to being performed by this apparatus.

The apparatus comprises means for monitoring 110, means for requesting 120, means for determining 130, means for providing 140, and means for informing 150. The means for monitoring 110, means for requesting 120, means for determining 130, means for providing 140, and means for informing 150 may be a monitoring means, requesting means, determining means, providing means, and informing means, respectively. The means for monitoring 110, means for requesting 120, means for determining 130, means for providing 140, and means for informing 150 may be a monitor, requester, determiner, provider, and informer, respectively. The means for monitoring 110, means for requesting 120, means for determining 130, means for providing 140, and means for informing 150 may be a monitoring processor, requesting processor, determining processor, providing processor, and informing processor, respectively.

The means for monitoring 110 monitors whether a base station receives an indication from a terminal (S110). The indication is received in a connection establishment procedure. The connection establishment procedure is for connecting the terminal with the base station in a connected state. The connection establishment procedure comprises at least one of the following: a random access procedure of the terminal, or a connection setup request of the terminal following the random access procedure of the terminal, or a connection resume request of the terminal following the random access procedure of the terminal. The indication indicates that a condition is met by performance measurements of at least one of one or more candidate cells performed while the terminal was not in the connected state (e.g. in idle state or in inactive state). The performance measurements may include EMR measurements. The connected state may be a RRC connected state.

If the indication is received from the terminal (S110=yes), the first means for requesting 120, means for determining 130, means for providing 140, second means for requesting 150, and means for informing 160 perform the following actions:

The first means for requesting 120 requests each of the one or more candidate cells to prepare as a secondary cell for carrier aggregation or dual connectivity for the terminal (S120). The means for determining 130 determines a suitable cell of the one or more candidate cells (S130). The performance measurement of the suitable cell meets the condition. S120 and S130 may be performed in a sequence S120-S130 or in a sequence S130-S120. They may be performed fully or partly in parallel.

The means for providing 140 provides the terminal with a configuration comprising the suitable cell as a secondary cell. The means for informing 150 informs the suitable node that the terminal is configured with the suitable cell as the secondary cell (S150).

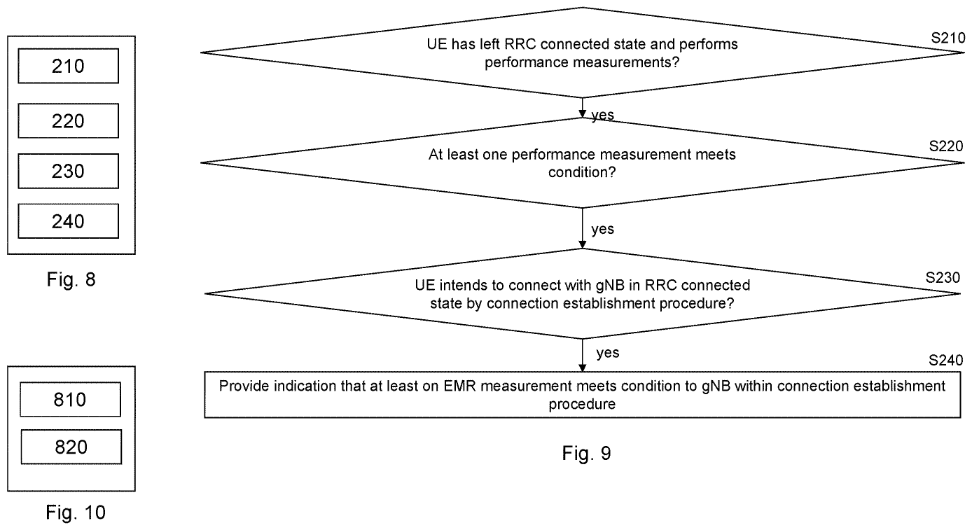

FIG. 8 shows an apparatus according to an example embodiment of the invention. The apparatus may be terminal (e.g. UE) or an element thereof. FIG. 9 shows a method according to an example embodiment of the invention. The apparatus according to FIG. 8 may perform the method of FIG. 9 but is not limited to this method. The method of FIG. 9 may be performed by the apparatus of FIG. 8 but is not limited to being performed by this apparatus.

The apparatus comprises means for monitoring 210, means for checking 220, means for supervising 230, and means for providing 240. The means for monitoring 210, means for checking 220, means for supervising 230, and means for providing 240 may be a monitoring means, checking means, supervising means, and providing means, respectively. The means for monitoring 210, means for checking 220, means for supervising 230, and means for providing 240 may be a monitor, checker, supervisor, and provider, respectively. The means for monitoring 210, means for checking 220, means for supervising 230, and means for providing 240 may be a monitoring processor, checking processor, supervising processor, and providing processor, respectively.

The means for monitoring 210 monitors whether a terminal has left a RRC connected state and performs performance measurements of one or more candidate cells while not being in the connected state (e.g. in the idle state or the inactive state) (S210). The performance measurements may include EMR measurements. The connected state may be a RRC connected state.

If the terminal has left the RRC connected state and performs the performance measurements (S210=yes), the means for checking 220, means for supervising 230, and means for providing 240 perform the following actions:

The means for checking 220 checks whether at least one of the performance measurements meets a condition (S220). The means for supervising 230 supervises whether the terminal intends to connect with a base station in the connected state by a connection establishment procedure (S230). The connection establishment procedure comprises at least one of the following: a random access procedure of the terminal, or a connection setup request of the terminal, or a connection resume request of the terminal.

S220 and S230 may be performed in a sequence S220-S230 or in a sequence S230-S220. They may be performed fully or partly in parallel.

If at least one of the performance measurements meets the condition (S220=yes) and the terminal intends to connect with the base station in the connected state by the connection establishment procedure (S230=yes), the means for providing 240 provides an indication to the base station (S240). The means for providing 240 provides the indication within the connection establishment procedure. The indication indicates that at least one of the performance measurements meets the condition. The indication may be explicit or implicit by using a dedicated preamble or RACH occasion in the random access procedure.

FIG. 10 shows an apparatus according to an example embodiment of the invention. The apparatus comprises at least one processor 810, at least one memory 820 storing instructions that, when executed by the at least one processor 810, cause the apparatus at least to perform the method according to at least one of the following figures and related description: FIG. 7 or FIG. 9.

Some example embodiments of the invention are useful for mm-wave frequencies (FR2). However, the invention is not limited to FR2 and may be applied to any frequency range.

Unless otherwise stated, the terms “node” and “cell” may be considered as synonymous. I.e., the “node” represents the corresponding “cell”.

Some example embodiments are explained with respect to a 5G network. However, the invention is not limited to 5G. It may be used in other communication networks, too, e.g. in previous of forthcoming generations of 3GPP networks such as 4G, 6G, or 7G, etc.

One piece of information may be transmitted in one or plural messages from one entity to another entity. Each of these messages may comprise further (different) pieces of information.

Names of network elements, network functions, protocols, and methods are based on current standards. In other versions or other technologies, the names of these network elements and/or network functions and/or protocols and/or methods may be different, as long as they provide a corresponding functionality. The same applies correspondingly to the terminal.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be deployed in the cloud.

According to the above description, it should thus be apparent that example embodiments of the present invention provide, for example, a base station (such as a eNB or gNB) or a component thereof, an apparatus embodying the same, a method for controlling and/or operating the same, and computer program(s) controlling and/or operating the same as well as mediums carrying such computer program(s) and forming computer program product(s). According to the above description, it should thus be apparent that example embodiments of the present invention provide, for example, a terminal (such as a UE, a MTC device, etc.) or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non-limiting examples, implementations as hardware, software, firmware, special purpose circuits or logic, general purpose hardware or controller or other computing devices, or some combination thereof. Each of the entities described in the present description may be embodied in the cloud.

It is to be understood that what is described above is what is presently considered the preferred example embodiments of the present invention. However, it should be noted that the description of the preferred example embodiments is given by way of example only and that various modifications may be made without departing from the scope of the invention as defined by the appended claims.

The terms “first X” and “second X” include the options that “first X” is the same as “second X” and that “first X” is different from “second X”, unless otherwise specified. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

1. Apparatus comprising:
one or more processors, and memory storing instructions that, when executed by the one or more processors, cause the apparatus to perform:
monitoring whether a base station receives an indication from a terminal within a connection establishment procedure of the terminal for connecting the terminal with the base station in a connected state that a condition is met by performance measurements of at least one of one or more candidate cells performed while the terminal was not in the connected state, wherein the connection establishment procedure comprises at least one of the following: a random access procedure of the terminal, or a connection setup request of the terminal, or a connection resume request of the terminal;
if the indication is received from the terminal:
requesting each of the one or more candidate cells to prepare as a secondary cell for carrier aggregation or dual connectivity for the terminal;
determining a suitable cell of the one or more candidate cells, wherein the performance measurement of the suitable cell meets the condition;
providing the terminal with a configuration comprising the suitable cell as a secondary cell;
informing the suitable cell that the terminal is configured with the suitable cell as the secondary cell.

2. The apparatus according to claim 1, wherein the instructions, when executed by the one or more processors, further cause the apparatus to perform
providing the terminal with a set of one or more preambles; wherein
the monitoring whether an indication is received from the terminal within the connection establishment procedure of the terminal that the condition is met by the performance measurements of at least one candidate cell by monitoring whether the terminal uses one of the preambles of the set of one or more preambles in the random access procedure.

3. The apparatus according to claim 1, wherein the instructions, when executed by the one or more processors, further cause the apparatus to perform
providing the terminal with an indication of a dedicated random access channel occasion; wherein
the monitoring whether an indication is received from the terminal within the connection establishment procedure of the terminal that the condition is met by the performance measurements of at least one candidate cell by monitoring whether the terminal selects the dedicated random access channel occasion in the random access procedure.

4. The apparatus according to claim 1, wherein the instructions, when executed by the one or more processors, cause the apparatus to perform
the monitoring whether an indication is received from the terminal within the connection establishment procedure of the terminal that the condition is met by the performance measurements of at least one candidate cell by monitoring whether the terminal provides an explicit indication in the connection setup request or the connection resume request.

5. The apparatus according to claim 1, wherein the instructions, when executed by the one or more processors, further cause the apparatus to perform at least one of the following:
providing the terminal with a measurement configuration for the performance measurements; or
providing the terminal with the condition.

6. The apparatus according to claim 1, wherein the instructions, when executed by the one or more processors, further cause the apparatus to perform, if there are more than one candidate cells:
releasing the candidate cells different from the suitable cell from becoming a secondary cell for carrier aggregation or dual connectivity for the terminal.

7. The apparatus according to claim 1, wherein the instructions, when executed by the one or more processors, cause the apparatus to perform, if there are more than one candidate cells:
the providing the terminal with the configuration comprising the suitable cell as the secondary cell by providing the terminal with a respective configuration for each of the candidate cells, wherein each of the configurations comprises the respective one of the candidate cells as the secondary cell; and
instructing the terminal to select the suitable cell among the candidate cells and to apply only the configuration for the suitable cell.

8. The apparatus according to claim 7, wherein the instructions, when executed by the one or more processors, cause the apparatus to perform
the providing the terminal with the respective configuration for each of the candidate cells not later than the requesting the report of the performance measurements from the terminal.

9. The apparatus according to claim 1, wherein the instructions, when executed by the one or more processors, cause the apparatus to perform, if there are more than one candidate cells:
the providing the terminal with the configuration comprising the suitable cell as the secondary cell by providing the terminal with only the configuration comprising the suitable cell as the secondary cell after the determining the suitable cell.

10. The apparatus according to claim 1, wherein the indication comprises an indication of the suitable cell.

11. The apparatus according to claim 1, wherein the instructions, when executed by the one or more processors, further cause the apparatus to perform
requesting a report of the performance measurements from the terminal; and
the determining the suitable cell of the one or more candidate cells by analyzing the report of the performance measurements.

12. The apparatus according to claim 1, wherein the instructions, when executed by the one or more processors, further cause the apparatus to perform
estimating the candidate cells among a set of potential candidate cells based on information about a primary cell the terminal is camping on.

13. (canceled)

14. A terminal comprising:
one or more processors, and memory storing instructions that, when executed by the one or more processors, cause the terminal to perform:
monitoring whether the terminal has left a connected state and performs performance measurements of one or more candidate cells while not being in the connected state;
if the terminal has left the connected state and performs the performance measurements while not being in the connected state:
checking whether at least one of the performance measurements meets a condition;
supervising whether the terminal intends to connect with a base station in the connected state by a connection establishment procedure, wherein the connection establishment procedure comprises at least one of the following: a random access procedure of the terminal, or a connection setup request of the terminal, or a connection resume request of the terminal;
if at least one of the performance measurements meets the condition and the terminal intends to connect with the base station in the connected state by the connection establishment procedure: providing an indication to the base station within the connection establishment procedure, wherein the indication indicates that at least one of the performance measurements meets the condition.

15. The terminal according to claim 14, wherein the instructions, when executed by the one or more processors, cause the terminal to perform:
the providing by providing an explicit indication in the connection setup request or the connection resume request.

16. The terminal according to claim 14, wherein the instructions, when executed by the one or more processors, further cause the terminal to perform
monitoring whether the terminal receives a set of one or more preambles; and wherein the instructions, when executed by the one or more processors, cause the terminal to perform
the providing the indication by using one of the preambles of the set of one or more preambles in the random access procedure.

17. The terminal according to claim 14, wherein the instructions, when executed by the one or more processors, further cause the terminal to perform
monitoring whether the terminal receives an indication of a random access channel occasion; and wherein the instructions, when executed by the one or more processors, cause the terminal to perform
the providing the indication by selecting the random access channel occasion in the random access procedure.

18. The terminal according to claim 14, wherein the instructions, when executed by the one or more processors, further cause the terminal to perform at least one of the following:
receiving a measurement configuration for the performance measurements, or
receiving the condition.

19. The terminal according to claim 14, wherein the instructions, when executed by the one or more processors, further cause the terminal to perform
monitoring whether the terminal receives a configuration from the base station, wherein the configuration comprises one of the candidate cells as a secondary cell for the terminal;
applying the configuration to the terminal if the terminal receives the configuration.

20. The terminal according to claim 19, wherein the instructions, when executed by the one or more processors, further cause the terminal to perform, if the measurement configuration comprises performance measurements of more than one candidate cell:
monitoring whether the terminal receives, from the base station, for each of the candidate cells, a respective configuration and an instruction to select only one of the configurations, wherein each of the configurations comprises the respective candidate cell as the secondary cell for the terminal;
selecting one of the candidate cells based on results of the performance measurements for the candidate cells if the terminal receives the configurations for the candidate cells and the instruction;
applying only the configuration for the selected candidate cell to the terminal.

21. The terminal according to claim 14, wherein the indication indicates additionally the candidate cell for which the performance measurement meets the condition.

22-46. (canceled)
